(19) United States
(12) Patent Application Publication
(10) Pub. No.: US 2009/0295230 A1
(43) Pub. Date: Dec. 3, 2009

(54) Selective coupling of a powered component

(75) Inventors: Seppo Rousu, Oulu (FI); Marko Leinonen, Haukipudas (FI); Juha Valtanen, Oulu (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/156,282

(22) Filed: May 30, 2008

(51) Int. Cl. H02J 7/34

(52) U.S. Cl. 307/80; 320/128

(57) ABSTRACT

An apparatus includes a switch controllable selectively to couple a powered component to a battery output connection or to a battery bypass circuit coupled to a charging input.

### FIELD OF THE INVENTION

The invention relates to apparatus controllable to couple a powered component to a source of power, to a method comprising selectively coupling a powered component, and to an apparatus comprising switch means.

### BACKGROUND

It is known to connect mobile telephones and other such devices to personal computers or mains chargers via a Universal Serial Bus (USB), a mini-USB, or a micro-USB connector.

### SUMMARY OF THE INVENTION

A first aspect of the invention provides an apparatus comprising a switch controllable selectively to couple a powered component to a battery output connection or to a battery bypass circuit coupled to a charging input.

The word ‘or’ is used here in an exclusive sense, in that the switch is controllable to couple the powered component to a power source comprising the battery output connection alone and also is controllable to couple the powered component to a power source comprising the battery bypass circuit alone. As will be appreciated from the following explanation, the switch may be controllable also to couple the powered component to a power source comprising the battery output connection and the battery bypass circuit.

The switch may be further controllable selectively to couple the powered component to both the battery output connection and the battery bypass circuit simultaneously.

The apparatus may comprise a plurality of batteries, each of the plurality of batteries having an associated battery output connection, and the switch may be controllable selectively to couple the powered component to one or more of the battery output connections.

The apparatus may further comprise a capacitor and the switch may be further controllable additionally to couple the powered component to the capacitor.

The switch may be part of a power management unit, and the operation of the power management unit may be controllable selectively dependent on whether the powered component is coupled to the battery output connection or to the battery bypass circuit. In this case, the operation of the power management unit may include a voltage conversion of power provided from the battery output connection or the battery bypass circuit.

The powered component may be a radio transceiver, for instance a radio transmitter.

The powered component may be an external device.

The switch may be controllable selectively to couple a first powered component to the battery bypass circuit and a second powered component to a battery output connection.

The switch may be controllable selectively to couple the powered component to the battery output connection or the battery bypass circuit coupled to the charging input based on one or more received signals. The one or more signals may be provided by one of, or any combination of, a power input detection circuit arranged to detect whether a charger coupled to the charging input and, if so, whether the charger meets predetermined requirements, an input current measurement circuit arranged to measure current arriving at the charging input, a detection unit for detecting whether an antenna is in a mismatch condition, a sensor for detecting whether the apparatus is located on top of a surface, a sensor for detecting an operational condition of the apparatus, a sensor for detecting an operational mode of the apparatus, a sensor for detecting a temperature of the apparatus, a sensor for detecting a motion of the apparatus, a radio frequency integrated circuit, a baseband processor, a transceiver and the power management module.

The charging input may be a USB connector. Alternatively, the charging input may be a non-USB battery charger input. Different non-USB battery chargers in connection with the non-USB battery charger input may provide different voltages. The apparatus may comprise a USB connector and a non-USB battery charger input.

The apparatus may be a portable communications device.

A second aspect of the invention provides a method comprising selectively coupling a powered component to a battery output connection or a battery bypass circuit coupled to a charging input.

The method may further comprise receiving one or more signals and selectively coupling the powered component to the battery output connection or the battery bypass circuit based upon the received one or more signals.

A third aspect of the invention provides an apparatus comprising switch means controllable selectively to couple a powered component to battery output connection means or to battery bypass circuit means coupled to charging input means.

### BRIEF DESCRIPTION OF THE DRAWINGS

FIG. 1 shows a mobile telephone terminal in which the invention can be embodied;

FIG. 2 shows an embodiment of an apparatus according to the invention;

FIG. 3 shows an exemplary power management unit of the apparatus of FIG. 2;

FIG. 4 shows an alternative schematic of the apparatus of FIG. 2;

FIG. 5 shows interferences between the apparatus of FIG. 2 and external devices;

FIG. 6 shows an embodiment of an apparatus according to the invention in connection with an external device;

FIG. 7 shows a flow-chart depicting a method of operation of embodiments of the invention; and

FIG. 8 shows flow chart depicting the method of operation as shown in FIG. 7 in more detail.

### DETAILED DESCRIPTION OF THE EMBODIMENTS

The word ‘connect’ is used in this specification is a sense that covers indirect connection and direct connection unless otherwise stated. The word ‘connect’ and the word ‘couple’ may be used interchangeably, and ‘connection’, ‘connected’, etc. may be interpreted accordingly.

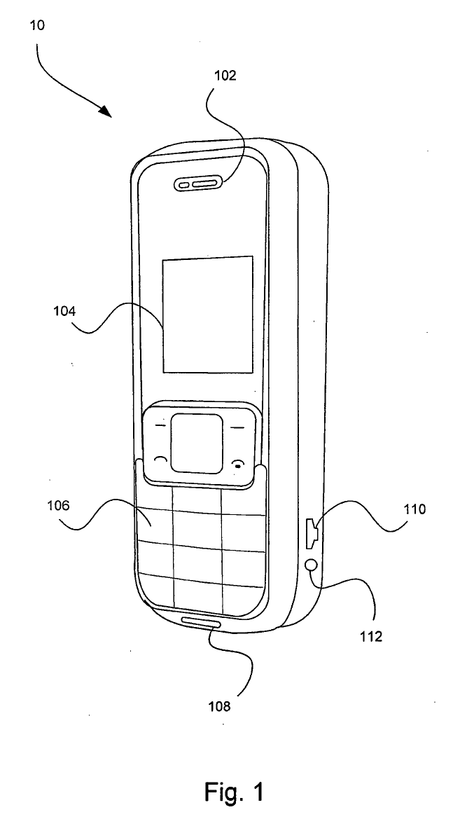

FIG. 1 shows a mobile terminal 10. The mobile terminal 10 is in this embodiment a mobile, or cellular, phone. Visible are a speaker 102, a display 104, a keypad 106, a microphone 108, a USB connector 110, and a non-USB battery charger input 112. The USB connector 110 may be a full-size USB connector, or a mini- or micro-USB connector. The display 104 may be a standard display screen or a touch screen display screen.

A USB charger may be inserted into the USB connector 110 to connect the mobile terminal 10 to various different power supplies such as, for example, a computer or a mains charger. An output connector of a mobile phone charger may be inserted into the non-USB battery charger input 112 in order to charge a battery (not shown in FIG. 1) of the mobile terminal 10.

The mobile terminal 10 may be a 3GPP Long Term Evolution (LTE) and WCDMA compatible device and is therefore capable of achieving high data transmission rates according to the standards set by the 3^{rd} Generation Partnership Project (3GPP).

While the embodiment is of a mobile terminal 10, it should be understood that the invention also applies to other devices having at least one transmission or reception functionality such as communicators, PDA devices, multimedia computers, location devices, modems, routers, repeaters, relays, femtocells, GPS receivers, digital television terminals, cameras with radios and video recorders with radios.

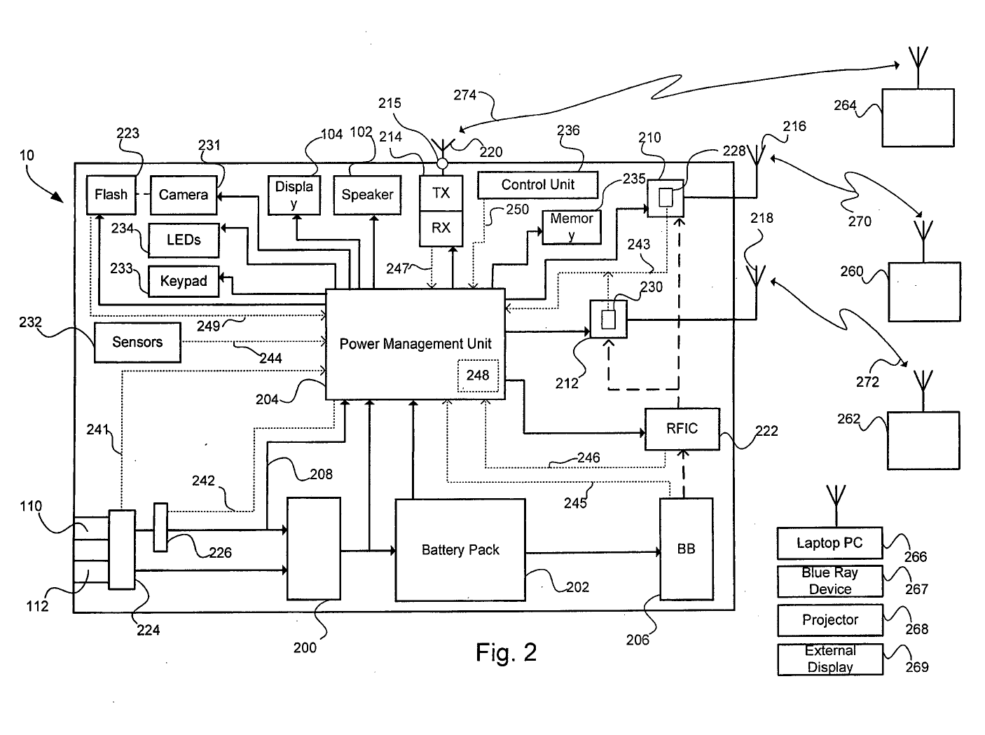

FIG. 2 is a schematic drawing of various components of the mobile terminal 10 and their various connections to one another. The mobile terminal 10 comprises the USB connector 110, and the non-USB battery charger input 112. The terminal 10 may include one or more additional charger inputs. The charger inputs may be connectable to chargers with different charging voltages. For example, a charger input may be connectable to a mains power supply (approximately 240V) and another charger may be connectable to a car power supply (which may be 12V, 24V or 48V for instance).

First and second inputs of a battery voltage converter 200 are connected respectively to the USB connector 110 and to the non-USB battery charger input 120. A battery pack 202 has an input connected to an output of the battery voltage converter 200. The battery voltage converter 200 is arranged to convert the voltages of power supplied to the USB connector 110 and non-USB battery charger input 112 to a voltage suitable for charging the battery pack 202. The battery pack 202 may comprise a single battery or a plurality of batteries. An output of the battery pack 202 is connected to a power management unit 204. Another output of the battery pack 202 is connected to a baseband processor 206.

The output of the battery voltage converter 200 is also connected to an input of the power management unit 204. One effect of this is that power provided to the non-USB battery charger input 112 at a high voltage (for example 48V) may be converted to a more suitable, lower voltage prior to being provided to the power management unit 204.

In electrical connection with the USB connector 110 is a battery bypass circuit 208. The battery bypass circuit comprises a direct electrical connection between the USB connector 110 and the power management unit 204. As such, there is a route for passing power from the USB connector 110 to the power management unit 204, bypassing the battery voltage converter 200 and the battery pack 202.

The battery bypass circuit 208 may additionally form a direct electrical connection (not shown in FIG. 2) between the non-USB battery charger input 112 and the power management unit 204. With this feature, there is a route for passing power from the non-USB battery charger input 112 to the power management unit 204, bypassing the battery voltage converter 200 and the battery pack 202. Outputs of the power management unit provide power to different components of the mobile terminal 10, as will now be described. A first output of the power management unit 204 is in connection with a power input of a first transceiver front-end unit 210. A second output of the power management unit 204 is in connection with a power input of a second transceiver front-end unit 212. A third output of the power management unit 204 is connected to a power input of a transceiver 214. Power can be controlled to be provided from the power management unit 204 to any required combination of the first and second transceiver front-end units 210, 212 and the transceiver 214 at a given time.

A fourth output of the power management unit 204 is connected to a power input of a radio frequency integrated circuit (RFIC) 222. An output of the baseband processor 206 provides data to an input of the RFIC 222. An output of the RFIC 222 is connected to signal inputs of both the first and second transceiver front-end units 210, 212. Two transceivers are formed by the first and second transceiver front-end units 210, 212 and the RFIC 222.

Each transceiver is a combination of a transmitter and a receiver. Each transmitter includes an RFIC, which converts digital input signals to analogue RF signals. The front-end units 210, 212 of each transmitter also include front-end circuitry, which amplify the analogue RF signals to a level suitable for transmission. The front-end circuitry also separates and/or combines received signals. Each transmitter also includes filters and switches. Usually, the power management unit 204 is controlled to provide power to only one of the first and second transceiver front-end units 210, 212 and the transceiver 214 at a given time. Outputs of the first transceiver front-end unit 210, the second transceiver front-end unit 212 are coupled to first and second antennas 216, 218, respectively. The first antenna may be suitable for transmitting at frequencies in the LTE/WCDMA band VII (2.5-2.69 GHz).

A first transceiver comprising the first transceiver front-end unit 210 and the RFIC 222 may operate in an LTE mode, which relates to transmission by the first antenna 216 in the LTE band. When the first transceiver 222, 210, is operating in the LTE mode, the first transceiver front-end unit 210 requires a first operational voltage. The second antenna 218 may be suitable for transmitting in any of the LTE/WCDMA bands I, II, IV, V, VII and the GSM quad band.

A second transceiver comprising the second transceiver front-end unit 212 and the RFIC 222 may operate in a WCDMA mode or a GSM mode, which relate to transmission by the second antenna 218 in the WCDMA or GSM bands respectively. When the second transceiver 222, 212, is operating in the WCDMA modes, the second transceiver front end-unit 212 requires a second operational voltage. When the second transceiver 222, 212, is operating in the GSM mode, the second transceiver front end-unit 212 may require a third operational voltage. The first, the second and the third operational voltage may differ from each other. The second and the third operational voltages may be lower than the first operational voltage. The first, second and third operational voltages may be in the region of 4V.

A third transceiver 214 is connected to a third antenna 220. If the third transceiver is operating as a diversity receiver or as a diversity transmitter, the third antenna 220 and the third transceiver 214 operates at the same frequencies as the first and second transceivers.

Alternatively the third transceiver 214 may operate at a different frequency from the frequencies at which the first and second transceivers operate. In this case the third transceiver 214 may operate as a complimentary radio connection such as Bluetooth™, wireless LAN, FM radio, GPS, DVB-H, and DVB-T.

The third transceiver 214 may also have an external connection 215. The third transceiver 214 may be connected to the third antenna 220 or to an external antenna via the external antenna connector 215. The external antenna may have an integrated low noise amplifier (LNA). When active circuitry, such as the LNA, is integrated into the external antenna, a power supply is required. Power can be provided via the antenna connector 215 or directly with a dedicated power supply connection.

Alternatively a second device, for example a TV set with a coaxial antenna connection may be connected to the terminal 10 by way of the antenna connector 215.

Additional outputs of the power management unit 204 are connected selectively to provide power to other power consuming components of the mobile terminal 10, such as, for example, a camera 231, a camera flash light 223 for the camera 231, the display 104, the speaker 102, a keypad 233, LEDs 234 and a memory 235.

In the mobile terminal 10, the power consuming components are the baseband processor 206, the first and second front-end transceiver units 210, 212, the transceiver 214, the RFIC 222, the camera 231, the camera flash light 223, the display 104, the speaker 102, the microphone 108 (not shown in FIG. 2), the keypad 233, the LEDs 234 and the memory 235. As with all electrical components, the efficiency of these powered components is less than 100% and, as such, during their operation a proportion of the power supplied to them is dissipated as heat.

The mobile terminal 10 further comprises a control unit 236 in communication with and arranged to control the operation of the various powered components. Typically the control unit 236 is a part of the baseband processor circuitry 206. The control unit 236 may include a communication system protocol processor, a radio interface for which may be provided by one of the transceivers 222, 210, 212, 214.

The mobile terminal 10 further comprises a power input detection circuit 224 which is interposed between the USB connector 110 and the non-USB battery charger input 112, and the battery voltage converter 200. The power input detection circuit 224 is operable to detect the presence of charging power at the USB connector 110 and/or the non-USB battery charger input 112. It is also configured to detect if a connected USB charger meets certain predetermined standards.

The mobile terminal 10 and devices connected to the mobile terminal 10 via the USB connector 110 may perform a “hand-shaking” protocol. Information exchanged during the “hand-shaking” protocol may include at least one of: device type identification; device vendor identification; power source maximum output information; battery capacity information; power requirements such as power allocation requirements and power duration information requirements; device power consumption information; device active RF interface information; active application information; and temperature information.

The power input detection circuit 224 is arranged to provide signals on a first signal line 241 to the power management unit 204. The signals are representative of the detected conditions.

Interposed between the power input detection circuit 224 and the battery voltage converter 200 is a USB current measurement circuit 226. The USB current measurement circuit 226 is arranged to measure current provided at the USB connector 110 and to provide representative signals via a second signal line 242 to the power management unit 204.

Forming part of the first transceiver front-end unit 210 is a first detection unit 228. Forming part of the second transceiver front-end unit 212 is a second detection unit 230. Each of the detection units 228, 230 may be implemented using a coupler or a directive coupler. Couplers detect transmission signal levels and directive couplers detect transmission signal levels and reflected signal levels from the antenna. A relative difference between transmitted and reflected signal levels may indicate a mismatch condition of an antenna.

Outputs of the first and second detection units 218, 220 are provided as representative signals via a third signal line 243 to the power management unit 204.

The mobile terminal 10 comprises a sensor 232. Multiple sensors may be included in the terminal 10, each of which may be capable to detect various operating conditions of the terminal 10. For example, a proximity sensor may be implemented to detect whether the mobile terminal 10 is located on a surface. A proximity sensor may also be used to detect if a flip or slide part of a flip- or slide-type mobile terminal is in an open or closed position. A temperature sensor may be included to detect an internal temperature of the terminal 10 or an ambient temperature outside the terminal 10. An acceleration sensor may be included to detect the orientation or the motion of the terminal 10. In any case, the sensor 232 provides representative signals via a fourth signal line 244 to the power management unit 204.

The baseband processor 206, the RFIC 222, and the transceiver 214 are arranged to provide signals via fifth, sixth and seventh signal lines 245, 246, 247, respectively, to the power management unit 204. The power management unit 204 itself provides an eighth signal 248. Other power consuming components may also be configured to provide signals to the power management unit 204. For example, the flash 223 may be configured to provide signals via a ninth signal line 249 to the power management unit 204. The control unit 236 may be configured to provide signals to the power management unit 204 via a tenth signal line 250.

In FIG. 2, the mobile terminal 10 is shown to be in communication with a number of the external devices. The first antenna 216 is in communication 270 with a first external device 260. The first external device 260 may be a base station, a relay, a router or another network element. The second antenna 218 is in communication 272 with a second external device 262. The second external device 262 may be a second mobile terminal. The third antenna 220 is in communication 274 with a third external device 264. The third external device 264 may be a headset for the mobile terminal, an external display or a broadcasting receiver system e.g. a FM-radio, DVB-T, DVB-H, or a GPS receiver system. The base band processor 206 may also be connected to with a suitable connection, for example, one or more of a laptop computer 266, a Blu-Ray™ device 267, a projector 268 and an external (HD) display 269.

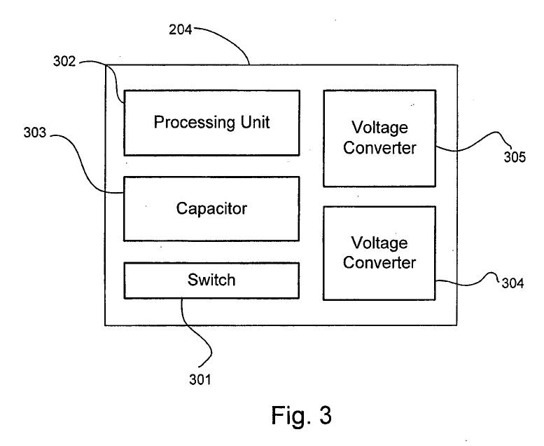

As can be seen in FIG. 3, the power management unit 204 comprises a one or more voltage converters 304, 305. These convert the voltage level of incoming power from the battery bypass circuit 208 or the battery pack 202 to a voltage level required by a particular component. The one or more voltage converters 304, 305 may alternatively be external to the power management unit 204.

As with all voltage converters, the battery voltage converter 200 and the power management unit voltage converters 304, 305 are not 100% efficient. Their actual efficiency varies according to a number of factors, such as, for example, input voltage, output voltage, input current, output current, peak current and duty cycle. Therefore, heat is generated within the mobile terminal 10 whenever voltage conversion is required. The voltage output by batteries of the battery pack 202 varies with time during charging. Consequently, voltage converter efficiencies, when converting from battery voltage to another voltage, may also vary during charging of the battery pack 202.

Typically, power provided from the USB connector 110 to a power consuming component, via the battery pack, requires two voltage conversions. For example, power provided to the USB connector 110 at 5V (the standard USB voltage) may be down converted by the battery voltage converter 200 to a voltage suitable for charging the battery pack 202. Standard mobile terminal batteries, for example Li-polymer batteries, require a charging voltage in the region of 3.6V. If the power from the battery is to be provided to, for example, the second transceiver front-end unit 212, a second voltage conversion from the battery voltage level to the first operational voltage, for example 4V will be required. The second voltage conversion is performed by the one of the two voltage converters 304, 305 of the power management unit 204. In some situations, the first and second voltage conversions together can generate some hundreds of mW heat.

Extra heat within the mobile terminal 10 can cause significant problems. For example, it is undesirable for the battery pack temperature become too great, when charging. Critical temperature varies according to a number of factors, including battery type. Also, the temperature of a memory unit (not shown) within the mobile terminal 10 should be kept low enough in order to avoid data corruption. Similarly, an RF crystal (not shown) forming part of the mobile terminal 10 needs to be kept sufficiently low in order to maintain RF performance within regulatory requirements. In addition to these and other performance considerations, the generation of excess heat may also be potentially harmful to users of the mobile terminal 10. Further, increased temperature of internal components can reduce available RF transmission power to such an extent that the transmission does not fulfil required performance specifications.

There are many known ways of reducing the temperature of devices, including using cooling fans or decreasing transmission power or data rates. Each has its disadvantages.

The mobile terminal 10 is operable such that, based on the signals provided to the power management unit 204, the power management unit 204 is controllable selectively to provide power to the power consuming components 104, 108, 210, 212, 214, 222, 223, 232, 233, 234 from one or a combination of power sources. The power source or combination of power sources is selected according to the power requirements of the power consuming components. The power source or combination of power sources is selected also according to which power sources are available. The power source or combination of power sources is selected also according to the characteristics (e.g. current, voltage and frequency) of the power provided by the available power sources. These power sources include the battery pack 202, the battery bypass circuit 208 (power from which may derive from the USB connector 110 or the non-USB battery charger input 112), a capacitor 303 (see FIG. 3, which is described below) and an external device (not shown).

The power needs of the system may change in a short period of time depending on the use of, for example, radio frequency (RF) air interfaces and applications. RF air interfaces may affect power consumption of the terminal due to a number of factors. These include: transmission signal power level; received signal power level; the number of uplinks and downlinks in use; signal modulation; the bandwidth of transmitted signals; the bandwidth of received signals; VSWR conditions in the antenna at reception and transmission frequencies; blocking and interfering signals detected by the receiver; and in the nature of transmission and reception activity.

Actions of a user may also effect the power consumption of the device. For Example, activation of the camera flash light may cause a long peak power consumption, which may result in a voltage drop being experienced by other power consuming components.

Also, GSM transmission, as well as other types of discontinuous transmission cause changes in current consumption, resulting in voltage drops depending on the power source used.

Power may be provided from the USB connector 110 to a powered component without first passing through the battery voltage converter 200 or the battery pack 202. This results in a reduced number of voltage conversions and therefore a reduced amount of heat being generated within the mobile terminal 10. As discussed, non-USB battery chargers may provide higher voltages than standard USB voltage and battery voltage. When this is the case, it may be advantageous to provide particular powered components with power provided by the non-USB battery charger without involving the battery, i.e. via a battery bypass circuit.

The current trend among new battery technologies is to provide lower operational voltages. This helps in extending a terminal's talk and standby times. An effect of lower battery voltage being provided, however, is that the performance of GSM transmission is degraded. Supplying power from the USB connection or the non-USB battery charger input without involving the battery, i.e. via a battery bypass circuit, reduces performance degradation in the presence of low battery voltage and thus is likely to be useful in an increasing number of mobile terminal designs.

As already mentioned, depending on the particular requirements of the powered component, the power management unit may provide power from a combination of the power sources. These combinations include, but are not limited to: the battery pack 202 and the battery bypass circuit 208; the battery pack 202 and the capacitor 203; and the battery pack 202 and the external device. As discussed, the battery pack 202 may comprise more than one battery. The power management unit 204 may be operable to provide power selectively from one or more of the batteries.

The power management unit may provide power to the camera flash light 223 and the second transceiver front-end unit 212 from separate batteries. This avoids an excessively large concurrent power consumption and subsequent voltage drop from a given battery power source. An excessively high voltage drop may degrade transmission parameters to such an extent that they do not meet specified linearity parameters for transmitted signals. Alternatively, power provided to the camera flash light may be reduced so as to provide a compromise between flash performance and available battery voltage. This may result in a reduced area of illumination by the camera flash light.

The first signal line 241 is used to convey signals provided by the power input detection circuit 224. The power input detection circuit 224 is configured to detect whether a USB charger is connected at the USB connector 110 and/or a non-USB battery charger is connected to the non-USB battery charger input 112. The power input detection circuit 224 also may be configured to detect whether a USB charger connected at the USB connector meets certain specifications. The power input detection circuit 224 may also detect when a charger is connected to the charger input 112 and the voltage provided by the connected charger. The first signal line 241 may indicate the detection and specifications of connected chargers.

The second signal line 242 is used to convey signals provided by the USB current measurement circuit 226. The USB current measurement circuit 226 is configured to measure current arriving at the USB connector 110 and the second signal line 242 may carry an indication of this measurement.

Provided by the first and second detection units 228, 230 are signals conveyed on the third signal line 243, which may indicate whether the first and second couplers 228, 230 detect that the either of the first and second antennas 216, 218 are in a mismatch condition. Alternatively, the third signal line 243 may include information about the transmission power level of the first and second transceivers 210, 212, 222.

The sensor 232 provides signals via the fourth signal line 244 which can indicate whether the sensor 232 detects a particular condition of the mobile terminal 10. The condition is dependent on the type of sensor implemented. For example, a proximity sensor may detect whether the mobile terminal 10 is located on a surface. A proximity sensor may also detect if flip or slide type mobile terminal is in an open or closed position. A temperature sensor may detect an internal temperature of the terminal or an ambient temperature outside the terminal. An acceleration sensor may detect the orientation or the motion of the terminal 10.

Signals conveyed on the fifth signal line 245 are provided by the baseband processor 206 and may be based on, for example, frequency band(s) of in-use radio frequency interfaces. The signals may also be based on transmission signal characteristics such as a transmission signal power, transmission signal quality, transmission signal frequency, transmission signal bandwidth, whether the transceiver is operating in TDD or FDD mode, or any combination thereof. Signals conveyed on the fifth signal line may be based on reception signal characteristics. These include, but are not limited to reception signal power, reception signal quality, and reception signal frequency. The signals may also or alternatively be based on, transmission or reception activity, the number of a sub-carriers, transmission or reception modulation type, the VSWR conditions of transmission or reception, transmission or transmission data rates, or any combination thereof.

The RFIC 222 provides signals via the sixth signal line 246 which are based on detected transmission or reception signal levels, frequency band(s) of active RF interfaces, transmission signal characteristics, transmission signal power, transmission signal quality, transmission signal frequency, transmission signal band width, operation mode (TDD or FDD), reception signal characteristics, reception signal power, reception signal quality, reception signal frequency, transmission or reception activity, the number of sub-carriers, transmission or reception modulation type, the VSWR conditions of transmission or reception, transmission or reception data rates, or any combination thereof.

The seventh signal line 247 conveys signals which may relate to the same information as the fifth or the sixth signals. Alternatively this signal may indicate whether an external device or unit is connected to an external antenna connector, such as the external antenna connector 215 of FIG. 2. Alternatively the signal may indicate that an antenna isolation measurement between antennas 220 and 216 is less than a predetermined threshold value. Alternatively, the signal may indicate whether an interference signal level due to transmission from the first antenna, detected by the third antenna 220 and the transceiver 214, is higher than predetermined level.

Signals conveyed on an eighth signal line 248 are generated by the power management unit 204. These signals may be dependent on the voltage of power provided to the power management unit 204.

A ninth signal line 249 may convey signals generated by one of the other powered components, for example, the flash 223 and may be activated if the flash 223 is required by the user.

A tenth signal line 250 provided from an output of the control unit 236 may convey signals dependent on, for example, operational conditions of the powered components controlled by the control unit 236. Operational conditions can include temperature of the whole or a part of the device, operational voltage, mode, and state of applications. Real time and non-real time software operations are considered separately.

FIG. 3 shows the power management unit 204 of the mobile terminal 10. The power management unit comprises a switch 301, a processing unit 302, a capacitor 303, and the first and second voltage converters 304, 305.

The capacitor 303 is able to be controlled by the power management unit to be operable as a supplementary power source, to provide supplementary power, when required. For example, the capacitor 303 may be required to supply power for the camera flash light 223. Power for the camera flash light may instead be provided from one or more of the other available power sources.

Power from the capacitor 303 may also be required to be provided to a powered component during a power supply transition. A power supply transition is when the powered component goes from being provided with power from a first power supply to being provided with power from a second power supply. Power from the capacitor 303 may also be provided to a powered component when a low interference (either conducted or radiated), between powered components or between radio interfaces within a device or between devices, is required.

It should be understood however, that one or more of the capacitor 303 and the voltage converters 304, 305 may not form part of the power management unit 204, but may be located elsewhere within the mobile terminal 10. For example, the capacitor 303 may be located in proximity to the powered component to which it supplies power, and may, therefore, be located in close proximity to, for example, the camera flash light 223.

The power management unit 204 is operable, depending on the requirements of the powered components, to provide power for charging the capacitor 303. The voltage converters 304, 305 are operable to convert the voltage of power provided to the power management unit 204 to a voltage required by the powered components. The voltage converters 304, 305 can provide different output voltages as required.

The processing unit 302 is arranged to receive signals via the first to tenth signal lines 241-250, and to control, based on the received signals, the switch 301 to provide power from one or more of the available power sources. The processing unit 302 may comprise analogue circuit, a micro processor, a micro controller or a dedicated digital logic circuit.

Alternatively, the first to tenth signal lines 241-250 may be connected to the control unit 236, and not be connected to the power management unit 204. In this way, signals conveyed on these lines may be received and processed by the control unit 236. The control unit 236 may form part of the baseband processor 206, may be external to the baseband processor 206 or may be divided between the baseband processor 206 and a location external to the baseband processor 206. The control unit 236 may sends signals, along a signal line (not shown), to the power management unit 204, containing instructions for controlling the power management unit 204.

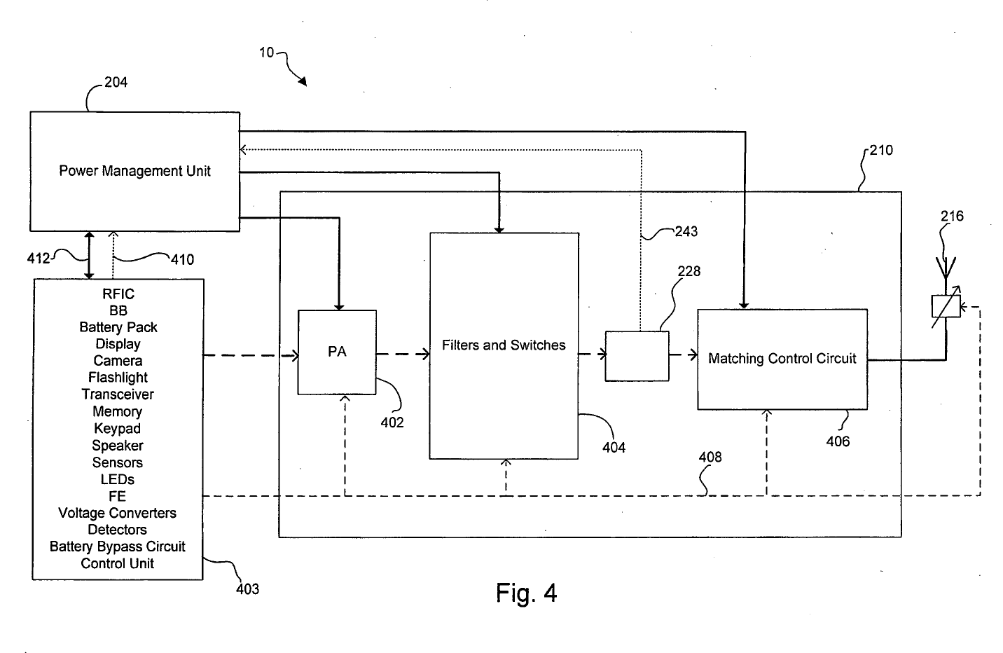

FIG. 4 shows an alternate schematic diagram of the mobile terminal 10 and is focused primarily on the first transceiver front-end unit 210. It should be appreciated that FIGS. 2 and 4 are different representations of the same device.

The first transceiver front-end unit 210 comprises a power amplifier 402. The power amplifier 402 is operable to amplify an incoming RF signal provided to a first input of the power amplifier 402 from, for example the RFIC 222. In this figure, the RFIC 222 is depicted as included in a main device unit 403 which represents all the components of the device 10 except for the power management unit 204, the first transceiver front-end unit 210 and the first antenna 216. The amplified RF signal is then provided from a first output of the power amplifier 402 to a first input of a filtering and switching unit 404. Having been processed by the filtering and switching unit 404, the amplified RF signal is then provided from a first output of the filtering and switching unit 404, via the first detection unit 228 to a first input of a matching control circuit 406 to the first antenna 216. The first antenna 216 may be a resonance frequency tuneable radiator.

Signals for controlling the operation of the power amplifier 402, the filtering and switching unit 404, the matching control circuit 406 and the first antenna 216 are provided via a plurality of signal lines 408 from the main device unit 403. The third signal line 243 provides an output of first detection unit 228 to the power management unit. The power management unit 204 also receives signals from the main device unit 401 via one or more signal lines 410. The one or more signal lines 410 may be one or more of the first, second, fourth, fifth, sixth, seventh, eighth, ninth or tenth signal lines 241, 242, 244, 245, 246, 247, 248, 249, 250 as shown in FIG. 2. Power is provided from components of the main device unit 400, for example, the battery pack 202 or the battery bypass circuit 208 (as discussed with reference to FIG. 2), to the power management unit 204, via one or more power lines 412. Power can be provided in the opposite direction, i.e. from the power management unit 204 to powered components, for example, the display 104 of the main device unit 400, via the one or more power lines 412.

A first output of the power management unit 204 is in connection with a power input of the power amplifier 402. A second output of the power management unit 204 is in connection with a power input of the filtering and switching unit 404. A third output of the power management unit 204 is in connection with a power input of the matching control circuit 406. The power management unit is operable to provide power to each of the power consuming components 402, 404, 406 of the first transceiver front-end unit 210 selectively from different sources or combinations of sources and at different voltages, depending on the requirements of each component.

In some embodiments, the transceiver front-end units 210, 212 comprise filters, filter modules and switches as integrated or discrete components. The switches have control inputs for selecting input and/or output ports, based upon on desired nodes in the antenna path. Switches intrinsically are non-linear components, but their linearity may be improved by providing a higher supply voltage. The higher supply voltage may be achieved by a voltage converter. The voltage converter may be one of the previously described voltage converters 200, 304, 305 or may be internal to the transceiver front-end unit 210, 212. Alternatively the higher supply voltage may be provided directly from the USB connector 110. The power management unit 204 is operable to provide power to each of the switching components of the first transceiver front-end unit 210 selectively from different sources or combinations of sources and at different voltages, depending on the requirements of each switching component.

It should be understood that the first transceiver front-end unit 210 may also receive incoming signals from the first antenna 216. These received signals may be provided to the main device unit 403 directly from the filtering and switching unit 404 and may not pass through the power amplifier 402.

The first, second and third transceivers 222, 210, 212, 214 may operate solely in a transmission or reception mode, i.e. not in transceiver mode, for periods of time. This may result in unused component functionalities. For example, if a transceiver is operating solely in a transmission mode during a transmission slot of a communication, the receiver component functionalities are unused. In this situation, the power management unit 204 may be controlled not to provide power to the receiver components.

There are a number of situations in which it may be beneficial for the power management unit 204 to provide power from the battery bypass circuit 208. There are also a number of situations in which it may be beneficial for the power management unit 204 to provide power simultaneously both from the battery bypass circuit 208 and the battery pack 202. Examples of such situations are described below.

A first such situation occurs when a high transmission power level is required. As discussed above, power received from the USB connector 110 and provided, to the power amplifier 402 of the first transceiver front-end unit 210 via the battery pack 202 requires two voltage conversions. However, if the power is provided by the battery bypass 208 circuit instead of by the battery 202, only one voltage conversion is required and a substantial part of the generated heat can avoided.

It is advantageous for the operation of power amplifiers to minimise their temperature. This is because a saturation condition is more likely to occur with increasing temperature. Although reduction in gain resulting from increased amplifier temperature can be compensated with an increased input power, the increase in input power drives the amplifier further towards the undesirable saturation condition. In the saturation condition, the gain of the amplifier is decreased and the output power from the amplifier is limited by the available operational supply voltage and current. As such this is clearly undesirable.

The control of the power management unit 204 to provide power from the battery bypass circuit 208 instead of the battery pack 202 allows the higher power level to be achieved. The need for high transmission power may be communicated to the power management unit 204 by the baseband processor 206 or by the RFIC 222 via the fifth or sixth signal lines 245, 246 respectively. On receiving a signal indicative of the higher power being required, the power management unit 204 is operated to provide power from the battery bypass circuit instead of from the battery pack 202.

A second situation occurs when one of the first and second antennas 216, 218 is in a mismatch condition. Antenna mismatch results in decreased antenna radiation which can be compensated for by increasing the operational power. This increase in operational power results in a higher operational current, which in turn results in increased heat generation. It is possible, however, to compensate to some extent for this extra heat. As has been explained, the number of voltage conversions can be minimised by controlling the power management unit to provide power to the relevant transceiver front-end unit 210, 212 from the battery bypass circuit 208 instead of the battery pack 202. An antenna being in a mismatch condition may be communicated to the power management unit by one of the first and second detection units 228, 230, via the third signal line 243.

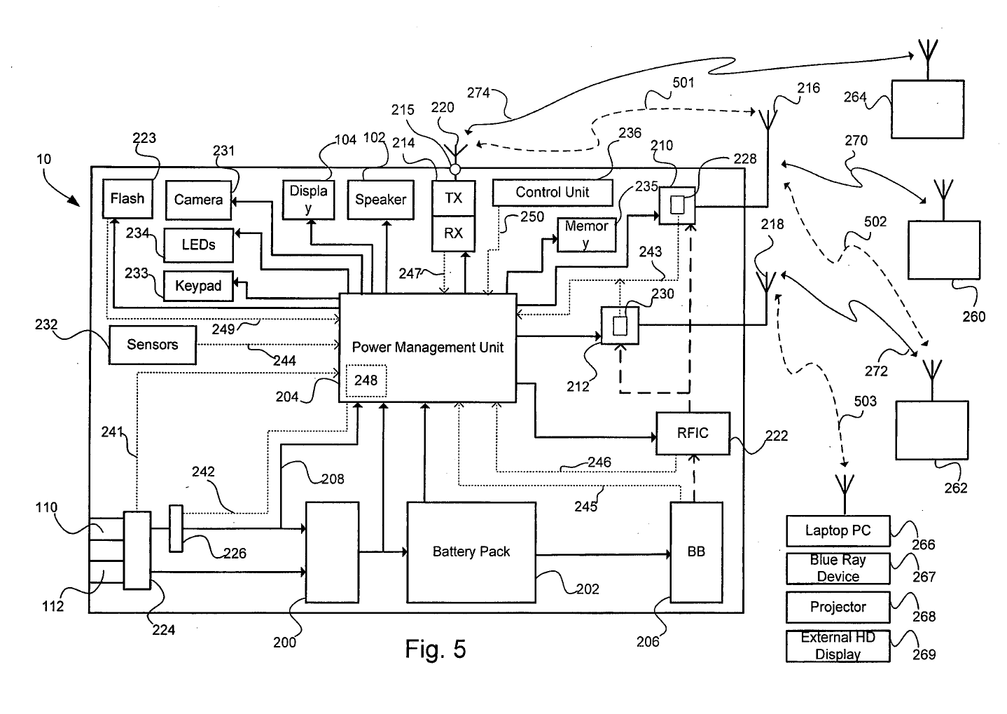

Another situation in which the required operational power may be is increased is when interference occurs. FIG. 5 illustrates some of the possible interferences that may be experienced by the mobile terminal 10. These include radio frequency interference 501 between two or more radio interfaces of the mobile terminal, such as, for example, the first and third antennas 216, 220. These also include radio frequency interferences between the radio interfaces of the mobile terminal and radio interfaces of an external device, for example interference 502 between the second terminal 262 and the first antenna 216 of the mobile terminal 10. They also include interference 503 between the second antenna 218 of the mobile terminal 10 and a radio interface of the laptop PC 266. Additionally, interference can be caused by camera flash light discharge and by using a relatively low battery voltage to generate high transmission power. Other possible interferences are internal to the mobile terminal 10 and include baseband processor 206 and clock interferences, display clock interferences, converter switch harmonics, interferences from charging circuitries, interference to or from the memory 235 and, if the invention is embodied in, for example, a laptop, interference from other removable memories, for example, DVDs, CDs or Blu-Ray™ discs.

Information regarding interferences may be communicated to the power management unit 204 from, at least, the control unit 236 via the tenth signal line 250. This information may include indications regarding which components are active or will be active within a predefined time period. It may indicate which components are experiencing interference or will experience interference during a predefined period. The information may also, or alternatively, include other operational information such as, for example, active software applications and component temperatures. Alternatively, the information may be communicated to power management unit 204, directly from the appropriate components instead of via the control unit 236.

In some situations, the required current may exceed the maximum current received at the USB connector 110 (the standard for USB is 500 mA, although this is known to vary). If this occurs, the power management unit 204 is controlled also to provide current from the battery pack 202, to supplement that provided by the battery bypass circuit 208. An example of such a situation is when an antenna mismatch is very large.

Conversely, if a surplus current is received at the USB connector, the surplus current is used to charge the battery pack 202. A surplus power is available for battery pack charging when powered components of the terminal 10 do not use all of the power provided to the non-USB battery charger input 112 and the USB connector 110.

The power management unit 204 may be controlled to operate accordingly in response to signals received at least one of the second, fifth or sixth signal lines 242, 245, 246 provided the USB current measurement circuit 226, the baseband processor 206 and the RFIC 222 respectively.

The power management unit may also be controlled to select a particular power source depending on whether an antenna 216, 218 is transmitting or receiving. For example, when an antenna is receiving, the power management unit 204 is controlled to provide power from the battery pack 202. This is advantageous because the power required during signal reception can be relatively low compared to that which may be required during signal transmission. Conversely, when one of the antennas, 216, 218 is transmitting at relatively high power, as has been discussed, the power management unit 204 can be controlled to provide power from the battery bypass circuit 208, therefore avoiding heat being generated by voltage conversion at the battery voltage converter 200. At least the third, fifth and sixth signal lines 243, 245, 246 may be used to effect control the power management unit in this situation.

When one of the antennas 216, 218 is transmitting at high power, leakage outside of a transmission channel or a transmission band can be problematic. However, leakage can be reduced if the operational voltage of power provided to the corresponding power amplifier 210, 212, is increased. Therefore, in this situation, as the power from the battery bypass circuit 208 is at a higher voltage than that from the battery pack 202, the power management unit 204 is controlled to provide power to the power amplifier from the battery bypass circuit 208 rather than the battery pack 202. This allows a higher operational voltage to be used, which can result in a higher linearity of the transmitter. This can decrease unwanted transmission outside of the transmission channel or transmission band. Transmission interference can be monitored for instance using a diversity receiver, for instance tuned to one of adjacent channels or one of the interference interfacing frequencies of transmission in a timely manner. Information about transmission leakage may be communicated to the power management unit 204 via one or more of the fifth, sixth and seventh signal lines 245, 246, 247.

Whether the power management unit 204 is controlled to provide power from the battery pack or the battery bypass circuit may also depend on whether the USB charger connected to the USB connector 110 meets certain predetermined requirements. Although USB current and voltage are intended to universally standard, this is not always the case and they may vary from one USB charger to another. This is particularly the case where the USB charger is a portable device such as a laptop or notebook computer. Different USB chargers may provide different power levels. Subsequently, if an unrecognised charger is detected at the USB connector 110, it cannot be assured that the charger can provide sufficient power to satisfy transmission requirements. In this sense, an unrecognised charger will be understood to mean a charger that is not known to be able to provide power in accordance with the USB standards. For instance, predefined chargers by a predefined manufacturer will be recognised as being suitable chargers, and chargers produced by other manufacturers may not be so recognised. Recognition, or otherwise, of the USB charger may be detected by the power input detection circuit 224 during handshaking with the USB charger. Alternatively, connection of a USB charger may be inferred by data communication between devices.

When an unrecognised USB charger is detected, the power management unit 204 is controlled to provide power from the battery bypass circuit 208 when a relatively low transmission power is required, and to provide power instead from the battery pack 202 when a high transmission power is required. This can be communicated to the power management unit 204 via the first signal line 241.

Signals sent via the first signal line 241 may also be used to indicate to the power management unit 204 that no USB charger is detected in connection with the USB connector 110. When no charger is detected, the power management unit 204 is controlled to take power only from the battery pack 202. The signals sent via the first signal line 241 may indicate an operational voltage of a connected charger. If multiple changers are connected to a terminal 10, then the signals sent via the first signal line 241 may indicate the operational voltages of each charger separately.

The power management unit 204 can also be controlled to provide power from a particular power source depending on the location of the mobile terminal 10. For example, if the sensor 232 detects that the mobile terminal 10 is located on a surface, this is communicated to the power management unit 204 via the fourth signal line 244. In response, the power management unit 204 is controlled to provide power from the battery bypass circuit 208 rather than the battery pack 202. This is advantageous since reduced convection of heat can occur when the mobile terminal 10 is located on a surface. As such, controlling the power management unit 204 in such a way that less heat is generated, i.e. by avoiding use of the battery voltage converter 200, can improve performance.

The switch 204 may also be controlled to utilise power from a power source which is selected depending on the actions of a user. For example, a user may wish to take a photograph using the flash 223 whilst the mobile terminal 10 is transmitting at, the power for which may ordinarily be provided from the battery pack. In this situation the power management unit 204 may be controlled to provide the power for the low power connection from the battery bypass circuit 208, thus allowing power for the flash 223 to be provided from the battery pack 202 or from a capacitor 303. A signal indicating that the user has effected an input requiring the use of the flash 223 may be communicated to the power management unit 204 via the ninth signal line 249.

In some situations, the mobile terminal 10 is required to be involved in multiple wireless connections simultaneously. In this case, the power management unit 204 is controlled to select the power source (e.g. the battery pack 202 or the battery bypass circuit or both) for each of the connections individually. The power source(s) for each connection may be selected based on one or more of the various considerations described above (i.e. mismatch condition, transmission levels, USB charger recognition etc). The power management unit 204 may be controlled to select the power source for each of the wireless connections based on the timing of the receipt or transmission of RF signals by the mobile terminal 10.

The USB connector 110 may be used for data transfer, as is conventional.

In the above, the power management unit 204 receives the various signals and, on the basis of these signals, decides whether to draw power from the battery bypass circuit 208, the battery pack 202 or both. Alternatively, a separate controller (not shown) may be arranged to receive the signals and provide suitable control signals to the power management unit 204. The exact way in which the relevant functionality is achieved may vary in different implementations of the invention.

Although the above embodiments controls the power management unit 204 on the basis of numerous received signals it will be appreciated that other embodiments include means of controlling the power management unit on the basis of only one such signal, and other embodiments include means to control the power management unit on the basis of a subset of the discussed signals.

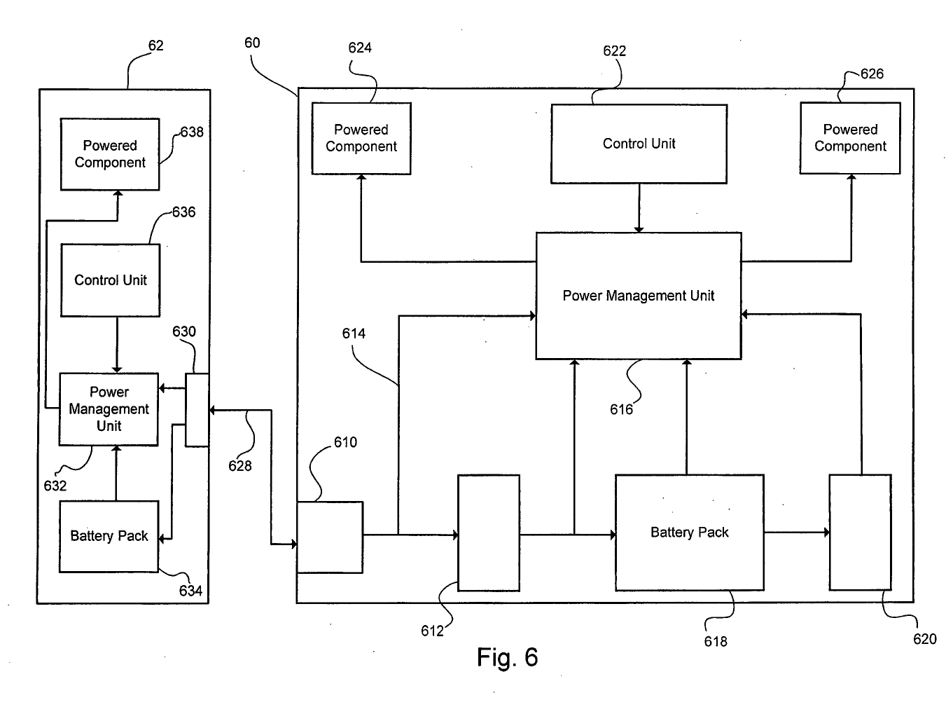

FIG. 6 depicts a first device 60, in which the invention is embodied, coupled to a second device 62. The first device 60 may be, for example, a laptop computer. The second device 62 may be, for example, a mobile telephone.

The first device 60 comprises a USB connector 610. An output of the USB connector 610 is in connection with an input of a first voltage converter 612. The first device 60 may comprise a plurality of USB connectors, whereby the first device 60 may be in connection with second device 62 and a USB charger (not shown) simultaneously. The output of the USB connector 510 is also in connection with an input of a battery bypass circuit 614. An output of the battery bypass circuit 614 is in connection with a first input of a power management unit 616. An output of the first voltage converter 612 is connected to an input of a battery pack 618. The battery pack 618 includes one or more batteries. The output of the first voltage converter 612 is also in connection with a second input of the power management unit 616. A second output of the battery pack 628 is in connection with an input of a second voltage converter 620. An output of the second voltage converter 620 is in connection with a third input of the power management unit 616. Alternatively, the second voltage converter 620 may be part of the power management unit 616.

The device 60 further comprises a control unit 622. An output of the control unit 622 is in connection with a fourth input of the power management unit 616. The control unit 622 is arranged to control first and second powered components 624, 626. The control unit 622 may also supply the power management unit 616 with information regarding the operation of the powered components 624, 626. This information enables the power management unit 616 to select an appropriate power supply or combination of power supplies for each of the powered components individually. The information supplied to the power management unit 616 may include information about current or upcoming interference conditions. First and second outputs of the power management unit 616 are in connection with the inputs of the first and second powered components 624, 626, respectively.

The power management unit 616 is arranged to provide power selectively to the powered components 624, 626. The powered components 624, 626 may be, for example, any of the powered components described with reference to FIG. 2. The device 60 may comprise more or fewer than the two powered components 624, 626 depicted in FIG. 6. The power management unit may provide power selectively to the powered components 624, 626 directly from the USB connector 610 via the battery bypass circuit 614, from the output of the first voltage converter 612, from the first output of the battery pack 618, from the output of the second voltage converter 620, or from a combination of these power supplies. For example, the power management unit 616 may provide power from the battery pack 618 and the battery bypass circuit 614 simultaneously.

It will be appreciated that the first device 60 is a simpler version of the device 10 described above with respect to FIG. 2. The first device 60 may alternatively be a device substantially as described above with reference to FIG. 2.

A USB connector 630 of the second device 62 is in connection with the USB connector 610 of the first device 60 via a USB cable 628. The USB connector 630 is in connection with a power management unit 632, the power management unit 632 being in bidirectional connection with a battery pack 634, which may comprise one or more batteries.

The first device 60 may comprise a non-USB battery charger input (not shown in the figure) for connecting the device to a non-USB battery charger (not shown in the figure) for charging the battery pack 628 of the device 60. Power provided from the non-USB battery charger (not shown) to the non-USB battery charger input (not shown) may be routed to the second device 62. The routing may occur via a dedicated power connection line (not shown). Alternatively, the routing may occur via the USB connection 628 between the two devices 60, 62.

The second device 62 further comprises a control unit 636 and a powered component 638, although it should be understood that the device may include more than one powered component. The powered components 624, 626 may be, for example, any of the powered components described with reference to FIG. 2. The control unit is arranged to control the powered component 638 and to provide information about the powered component 638 to the power management unit 632. The power management unit 632 may also receive signals direct from the powered component(s) via signal lines (not shown). The control unit 636 may receive power from the battery pack 634 or the power management unit 632 or from the non-USB battery charger (not shown) connected directly to the first device 60 (although the connections are not shown). In connection with a first output of the power management unit 632 is an input of the powered component 638. Based on at least the information received from the control unit 636, the power management unit 632 is controlled to provide power to the powered component 638 selectively from either the battery pack 632, the USB input connector 630, or from the non-USB battery charger (not shown) connected to the first device or from any combination of these three power sources.

It will be appreciated that the second device 62 is a simpler version of the device 10 described above with respect to FIG. 2. The second device 62 may alternatively be a device substantially as described above with reference to FIG. 2.

The battery bypass circuit 614 of the first device 60 may also enable power to be provided from the power management unit 616 of the first device to the USB connector 610 of the first device. Therefore, the power management unit 616 of the first device 60 may be controlled to provide power to the second device 62 from either the battery pack 618 of the first device 60 or, if the USB input connector 610 is in connection with both the second device 62 and a USB charger (not shown), from the USB charger, or from both simultaneously.

The control units 622, 636 of the first and second devices 60, 62 may be in data connection, via the USB cable 628 or in some other way. In this way, information regarding the power requirements of the second device 62 may be provided from the control unit 636 of the second device to the control unit 622 of the first device 62. This may, in turn, provide information to the power management unit 616 of the first device 60 instructing the power management unit 616 of the first device 60 to provide power to the second device 62. The information provided from the control unit 636 of the second device 62 may also indicate to the power management unit 616 of the first device 60 from which power sources power should be provided. It will be understood that power may also be provided from the second device 62 to the first device 60 via a similar transfer mechanism.

The second device 62 may communicate via the USB connector 110 to the first device 60, via the USB connection 628, the amount of power required. Based on this information, the first device 60 may control its hardware, e.g. regulators, such as to provide the required power whilst preserving its battery.

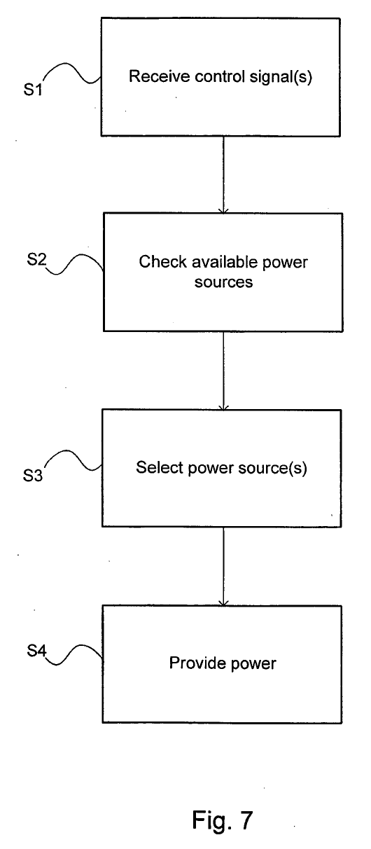

A method of operation of the mobile terminal 10 or the first device 60 will now be described with reference to FIG. 7.

At step S1, one or more signals are received at the power management unit 204. At step S2, the power management unit 204 checks, based on the received signals or otherwise, which of the power sources are currently available to provide power and, at step S3, selects a power source from which to provide power to a powered component. The power management unit 204 may select to provide power to the powered component from the battery bypass circuit 208 (which may derive power from either the USB connector 110 or the non-USB battery charger input 112), the capacitor 303, an external device, or the battery pack 202. Alternatively, the power management unit 204 may select to provide power to the powered component from a combination of the above power sources. These combinations include the battery pack 202 and the battery bypass circuit 208, the battery pack 202 and the capacitor 203, the battery pack 202 and the external device. As discussed, the battery pack 202 may comprise more than one battery and the power management unit 204 is operable to provide power from selectively from one or more of these batteries.

In step S3, the power management unit 204 selects the power sources, or combination of power sources, which is most suitable in order to fulfil at least one of the following criteria: the minimisation of heat generation within the device; the minimisation of transmission interferences; the minimisation of interference between powered components; the maximisation of voltage converter efficiency; and the maximisation of the efficiency of powered components.

At step S4, the power management unit 204 provides the power incoming from the selected power source or combination of power sources to the powered component. This step may include, if required, converting the voltage of the incoming power to a voltage required by the powered component. Also, this step may include providing power from a selected power source or selected combination of power sources to a connected external device.

The powered component may be, for example, one of the first and second amplifiers 210, 212, the transceiver 214, the RFIC 222, the baseband processor 206, the camera 231, the camera flash light 223, the display 104, the speaker 102, the keypad 233, the LEDs 234 and the memory 235.

Step S1 of receiving one or more signal lines may comprise receiving the signal lines from one or more of the charger input detection circuit 224, the USB current measurement circuit 226, the first or second detection units 228, 230, the sensor 232, the baseband processor 206, the RFIC 222, the transceiver 214, the power management module 250 204, and the flash 223.

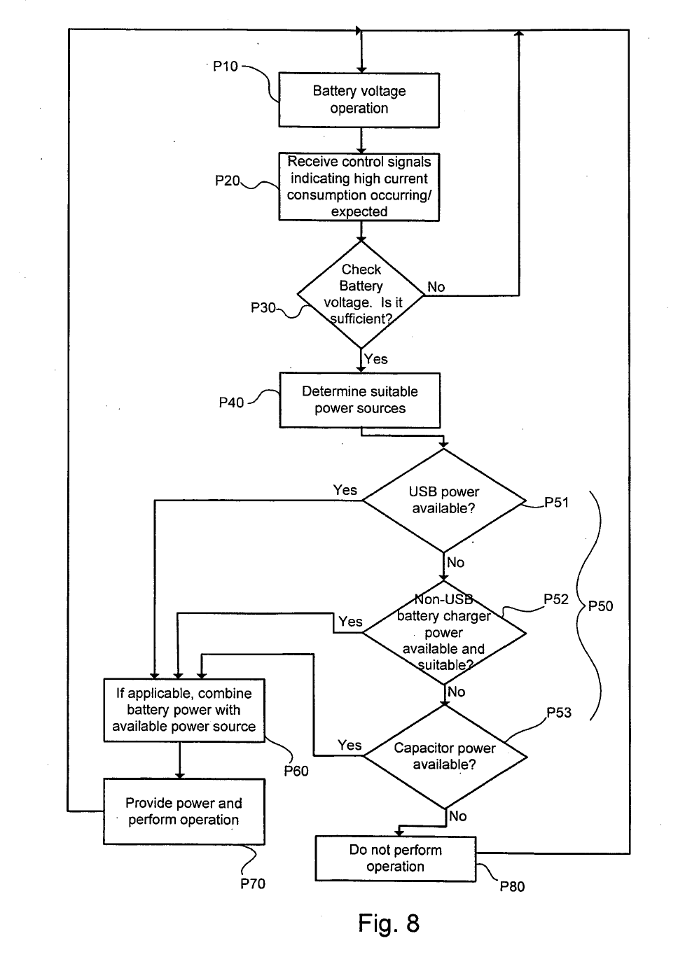

FIG. 8 is a flow chart showing, in greater detail, the method of operation of the mobile terminal 10 or the first device 60, as described with reference to FIG. 7.

In step P10, the device is operating in a normal mode, wherein a powered component is being provided with power derived from the battery pack 202. In the next step P20, the power management unit 204 receives signals indicating that the powered component requires the provision of power from a different power source. The signals may be control signals sent to the power management unit 204 via one or more of the first to tenth signal lines 241-250. In this case, the processing unit 302 processes the control signals and determines that a change in power supply is required. Alternatively, the control unit 236 may receive the control signals and, based on the control signals, determine that the powered component requires a change of power supply. The control unit 236 then sends to the power management unit 204 an indication that the powered component requires a change of power supply.

A change in power supply may be required if, for example, it is detected that the powered component itself, or another component related to the powered component, is experiencing interference. A change is power supply may also be required based on expected situations. Examples of such expected situations are, for example, an expected interference between two powered components or two RF interfaces, or an expectation of high current consumption by the powered component. An expectation of high current consumption occurs, for example, if discontinuous transmission is about to commence or if the camera flash light is required. A high current being drawn from a battery can result in a reduction in the output voltage. The amount of current that is required by a particular powered component when performing particular operations is pre-stored on a memory of the mobile terminal. The reduction in output voltage due to high current consumption by particular powered components when performing particular operations may also be pre-stored in a memory of the mobile terminal.

A reduction in output battery voltage also occurs if a battery level is relatively low. The battery output voltage can be detected using, for example, voltage detection circuitry. In step P30, the output voltage provided by the battery pack 202 is detected. Based on this detection, it is determined, by calculating the known voltage reductions due to upcoming operations by powered components, whether the battery output voltage is sufficient to satisfy the demand resulting from the upcoming operations. If the output battery voltage is sufficient to satisfy the upcoming demand, the mobile terminal returns to step P10 and continue to operate in normal mode. If, however, the battery output voltage is found to be insufficient, the method proceeds to step P40.

The most suitable power source or sources from which to provide power to a powered component for performing a particular operation is pre-stored, for instance in a look-up table, which is stored in a memory of the mobile terminal 10. If the camera flashlight 223 is required, the capacitor 303 may be the most suitable power source. Conversely, if discontinuous transmission is about to be performed by the first transceiver 222, 210, the most suitable power source may be USB power provided via the battery bypass circuit 208. In step P40, the look-up table is checked and the most suitable power source is determined.

Once the most suitable power source or sources has/have been determined, the method proceeds to step P50. In step P50 the availability of the various power sources is checked. The order in which the availability of the power sources is checked varies according to the determination (in step P40) as to which power source or sources is/are the most suitable. In the example which is illustrated in FIG. 8, the most suitable power source has been determined to be USB power. Consequently, in step P51, the mobile terminal checks if USB power is available. This may be determined on the basis of signals received by the power management unit 204 or the control unit 236 from the power input detection circuit 224, via the first signal line 241. Alternatively, the availability of USB power may already be known as a result of handshaking protocols between the mobile terminal and a device with which the mobile terminal is connected by USB connection. If USB power is found to be available, the method proceeds to step P60.

If, however, USB power is determined at step P51 to be unavailable, the availability of the next most suitable power source is checked in step P52. In the case of the example which is illustrated in FIG. 8, the next most suitable power source is a non-USB battery charger. The availability of the non-USB battery charger may be determined based on signals received by the power management unit 204 or the control unit 236 from the power input detection circuit via the first signal line 241. If present, the suitability of the non-USB battery charger is checked. Output voltage from the non-USB battery charger may include electrical interferences such as harmonics of a regulator switch, and thus may not be suitable for all powered components. Alternatively, the output voltage provided by the non-USB battery charger may be too high for some powered components. If this is the case, the voltage of power from the non-USB battery charger can be downconverted by, for example, the voltage converter 200 so as to make it suitable prior to delivery to the powered component. The downconversion may instead be performed by either of the voltage converters 304, 305 of the power management unit. If the non-USB charger power is found in step P52 to be available and suitable (following downconversion or other operation as appropriate), the method proceeds to step P60.

If the non-USB charger is found to be unavailable or unsuitable, the mobile terminal 10 determines, in step P53, if the capacitor 303 is available. Voltage detection circuitry may be used to determine if the capacitor 303 is charged to a sufficient voltage. If it is determined that the capacitor 303 is charged to a sufficient voltage, the method proceeds to step P60. The mobile terminal 10 may comprise multiple capacitors, each having a different capacity. The mobile terminal 10 may select an appropriate one of the multiple capacitors based on the current or voltage required to carry out a particular operation. If no suitable capacitor is found to be available, the method proceeds to step P80, in which it is determined that the upcoming operation cannot be performed. The mobile terminal then returns to operating in normal mode.

It will be appreciated that FIG. 8 illustrates one example order for steps P51 to P53. Different outcomes from step P40 may result in different orders for the steps P51 to P53.

For instance, if in step P40, it is determined that the capacitor 303 is the most suitable power source, the order of steps P51, P52, and P53 will be changed. For example, the mobile terminal performs step P53 first to determine if the capacitor 303 is available. If available, the method proceeds to step P60. If it is determined if the capacitor 303 is unavailable, the mobile terminal then performs step P51 and determine if USB power is available. If available, the method proceeds to step P60. If it is determined that USB power is unavailable, the mobile terminal performs step P52 and determines if non-USB battery charger power is available. If available, the method proceeds to step P60. If unavailable, the method proceeds to step P80.

In some situations only one power source may be suitable. In such situations, it is not relevant whether the other, unsuitable power sources are available. To this end, the mobile terminal performs only the relevant step, for example step P53, to determine if the capacitor is available. If the suitable power source is found to be unavailable, rather than checking if the other power sources are available, the method proceeds directly to step P80 and determines that the operation cannot be performed.

In step P60, having determined in previous steps that a suitable power source is available, the mobile terminal determines if the suitable power source requires combination with power from the battery pack. This may occur, for example, if the USB voltage is not quite sufficient to enable the powered component to perform a particular operation. In this case, the USB voltage can be combined with a portion of the available battery voltage. Having determined whether or not power from the suitable power source requires combination with power from the battery, the power management unit 204, in step P70, provides the power to the powered component and the upcoming operation is performed.

The flow chart of FIG. 8 is merely illustrative and not limiting. Methods within the scope of the claims can combine power from two power sources other than the battery pack 202, either with or without power from the battery pack 202.

It should be realised that the foregoing examples should not be construed as limiting. Other variations and modifications will be apparent to persons skilled in the art upon reading the present application. For instance the switch 310 may be external to the power management unit 204. Moreover, the disclosure of the present application should be understood to include any novel features or any novel combination of features either explicitly or implicitly disclosed herein or any generalisation thereof and during the prosecution of the present application or of any application derived therefrom, new claims may be formulated to cover any such features and/or combination of such features.

1. An apparatus comprising a switch controllable selectively to couple a powered component to a battery output connection or to a battery bypass circuit coupled to a charging input.

2. An apparatus according to claim 1, wherein the switch is further controllable selectively to couple the powered component to both the battery output connection and the battery bypass circuit simultaneously.

3. An apparatus according to claim 1, wherein the switch is part of a power management unit and wherein the operation of the power management unit is controllable dependent on whether the powered component is coupled to the battery output connection or to the battery bypass circuit.

4. An apparatus according to claim 3, wherein the operation of the power management unit includes a voltage conversion of power provided from the battery output connection or the battery bypass circuit.

5. An apparatus according to claim 1, wherein the powered component is a radio transmitter, for instance a transceiver.

6. An apparatus according to claim 1, wherein the powered component comprises an external device.

7. An apparatus according to claim 1, wherein the switch is controllable selectively to couple a first powered component to the battery bypass circuit and a second powered component to a battery output connection.

8. An apparatus according to claim 1, wherein the switch is controllable selectively to couple the powered component to the battery output connection or to the battery bypass circuit coupled to the charging input or to an alternative power supply based on one or more received signals.

9. An apparatus according to claim 8, wherein one of the one or more signals is provided by a power input detection circuit arranged to detect whether a charger coupled to the charging input and, if so, whether the charger meets predetermined requirements.

10. An apparatus according to claim 8, wherein one of the one more signals is provided by an input current measurement circuit coupled at the charging input.

11. An apparatus according to claim 8, wherein one of the one more signals is provided by a detection unit for detecting whether an antenna is in a mismatch condition

12. An apparatus according to claim 8, wherein one of the one more signals is provided by a sensor for detecting-whether the apparatus is located on top of a surface.

13. An apparatus according to claim 1 wherein the charging input a USB connector.

14. A method comprising:
selectively coupling a powered component to a battery output connection or a battery bypass circuit coupled to a charging input.

15. A method according to claim 14, further comprising:
receiving one or more signals and selectively coupling the powered component to the battery output connection or the battery bypass circuit based upon the received one or more signals.

16. Machine-readable instructions which when executed by computer apparatus control it to perform the method of claim 14.

17. Computer-readable media having stored thereon machine readable instructions which when executed by computer apparatus control it to perform the method of claim 14.

18. An apparatus comprising switch means controllable selectively to couple a powered component to battery output coupling means or to battery bypass circuit means coupled to charging input means.

19. An apparatus according to claim 18, wherein the switch means is further controllable selectively to couple the powered component to both the battery output coupling means and the battery bypass circuit means simultaneously.

20. An apparatus according to claim 18, wherein the switch means is part of power management means and wherein the operation of the power management means is controllable dependent on whether the powered component is coupled to the battery output coupling means or to the battery bypass circuit means.

21. An apparatus according to claim 20, wherein the operation of the power management means includes a voltage conversion of power provided from the battery output coupling means or the battery bypass circuit means.

22. An apparatus according to claim 18, wherein the switch means is controllable selectively to couple a first powered component to the battery bypass circuit means and a second powered component to a battery output coupling means.

23. An apparatus according to claim 18, wherein the switch means is controllable selectively to couple the powered component to the battery output connection means or the battery bypass circuit coupled to the charging input means based on one or more received signals.

24. An apparatus according to claim 23, wherein one of the one or more signals is provided by power input detection circuit means arranged to detect whether a charger means coupled to the charging input and, if so, whether the charger means meets predetermined requirements.

25. An apparatus according to claim 18 wherein the charging input means is a USB connector.
